(19) United States
(12) Patent Application Publication
(10) Pub. No.: US 2007/0080176 A1
(43) Pub. Date: Apr. 12, 2007

(54) Grill utensil with built-in seasoning dispenser

(76) Inventor: Shane J. Hunter, Charlotte, NC (US)

Correspondence Address: Shane J. Hunter, 7106 Swordgate Drive, Charlotte, NC, 28226, US

(21) Appl. No.: 11/246,898

(22) Filed: Oct. 8, 2005

(51) Int. Cl. B67D 1/07; A47G 19/00

(52) U.S. Cl. 222/192; 222/142.1

(57) ABSTRACT

A cooking utensil having a dispenser for salt, pepper or other seasonings built into its handle. The dispenser is created from a hollow portion of the utensil handle, and includes a lid and perforations for loading and dispensing the seasoning in particulate form therefrom. The dispenser portion of the handle may be separated by the user from the rest of the handle by unscrewing or otherwise disengaging the two portions from one another. The invention may be used in any cooking utensil, and two or more utensils with built-in dispensers may be incorporated into a set of utensils, such as a set of grill tools.

### CROSS-REFERENCE TO RELATED APPLICATION

This application claims the benefit of, and claims priority to provisional U.S. patent application Ser. No. 60/616,728, filed on Oct. 7, 2004, which is incorporated herein by reference in its entirety.

### BACKGROUND OF THE PRESENT INVENTION

1. Field of the Present Invention

The present invention relates generally to cooking utensils, and, in particular, to grill or barbecue tools having a built-in salt, pepper or other seasoning dispenser.

2. Background

Outdoor grilling and other types of cooking outside the confmes of a conventional kitchen are wildly popular activities. Unfortunately, outdoor grilling typically requires the availability of a considerable number of items to the grill. Such items may include tools, charcoal, matches, lighter fluid, condiments, seasonings and the food itself. When these items are stored adjacent the cooking area, it is a simple matter to retrieve the necessary items when needed. However, for outdoor grilling and some other types of cooking, the items must often be carried from a storage area in a kitchen to an outdoor area such as a deck or backyard, or must be transported to a park, campsite or other remote outdoor location. Not only is it frequently difficult to carry all of the necessary items, but because so many items are involved, it is also frequently difficult for the cook to remember everything.

Thus, a need exists for minimizing the number of separate items that must be remembered and carried from a storage area to a cooking site.

### SUMMARY OF THE PRESENT INVENTION

The present invention comprises a grill utensil that includes a built-in seasoning dispenser. The dispenser is arranged in the handle of the utensil. Broadly defmed, the present invention according to one aspect is a combined cooking utensil and seasoning dispenser, including: an operational tool; a shaft, having a first end connected at one end to the operational tool and a second end opposite the first end; and a hollow portion, connected to the second end of the shaft and adapted to store a seasoning in particulate form, with openings for shaking the seasoning therethrough.

In another aspect, the present invention is a combined cooking utensil and seasoning dispenser, including: a first element with having a hollow portion adapted to store a seasoning in particulate form, the hollow portion including openings for shaking the seasoning therethrough and a first connective fitting; and a second element having a second connective fitting at a first end and an operational tool at a second end, the second end being opposite the first end, wherein the second connective fitting is adapted to mate with the first connective fitting.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a side perspective view of a grill utensil with built-in seasoning dispenser in accordance with the preferred embodiments of the present invention;

FIG. 2 is a side cross-sectional view of the grill utensil of FIG. 1;

FIGS. 3A & 3B are perspective views of an exemplary cap for use with the grill utensil of FIG. 1; and

FIG. 4 is a side perspective view of the grill utensil of FIG. 1, shown with the first handle portion separated from the second handle portion.

### DETAILED DESCRIPTION OF THE PREFERRED EMBODIMENTS

Referring now to the drawings, in which like numerals represent like components throughout the several views, the preferred embodiments of the present invention are next described. The following description of the preferred embodiment(s) is merely exemplary in nature and is in no way intended to limit the invention, its application, or uses.

FIG. 1 is a side perspective view of a grill utensil 10 with built-in seasoning dispenser in accordance with the preferred embodiments of the present invention. The utensil 10 includes an operational tool 12, a shaft 14 and a handle 20. As used herein, the term “operational tool” will be understood to mean and refer to any cooking, grilling or food handling utensil. As shown, the operational tool 12 is a spatula, but it will be apparent that the operational tool 12 may be any conventional operational tool, including a fork of any number of tines, a slotted or solid spoon, a knife, a basting brush, tongs, a probe, or the like.

The shaft 14 is simply an elongated body having first and second opposing ends 16, 18, wherein the first end 16 is connected to the operational tool 12. The shaft 14 may be of conventional construction, and may be connected to the operational tool 12 using conventional means, including chemically means, such as adhesives or glues, or mechanically, such as by screws or the like, or may be integrally formed with the operational tool 12.

The handle 20 is also an elongated body having first and second opposing ends 22, 24. However, at least a portion of the handle 20 preferably has a thickness adapted to fit comfortably in a user's hand in order to facilitate manipulation of the utensil 10 by the user. The first end 22 of the handle 20 is connected to the shaft 14. The handle 20 may be connected to the shaft 14 using conventional means, or may be integrally formed with the shaft 14 if desired.

FIG. 2 is a side cross-sectional view of the grill utensil 10 of FIG. 1. As illustrated therein, the handle 20 further includes a hollow section 26 arranged near the second end 24 thereof. The hollow section 26 is adapted to store salt, pepper, or other spices, seasonings or foodstuffs therein in particulate form. An access opening 28, covered by a lid or cap 32 as shown in FIG. 2, permits the hollow section 26 to be filled with the desired foodstuff by removing the cap 32 and filling the interior. The cap 32 is preferably constructed of a washable, resilient material such as plastic, wood, metal, or rubber. The cap 32 may be held in place via any conventional means, including threads, tabs, clips, pressure fittings, clamps, twist fittings and the like.

A plurality of perforations or other small openings 30 are arranged in the end cap 32 or in one or more walls of the hollow section 26 in order to permit the passage of the seasoning particulates to pass therethrough when the handle 20 is shaken. As shown, the perforations 30 are disposed in the periphery of the cap 32, but it will be apparent that they may be disposed in the top of the cap 32 or in the walls of the hollow section 26, but are preferably located at or close to the second end 24 so that the seasoning will be unlikely to pass therethrough when the operational tool 12 is in use (i.e., when the utensil 10 is in its upright “in use” orientation). Optionally, means may be included in the cap 32 or the hollow section 26 for separately covering the perforations 30 when not in use.

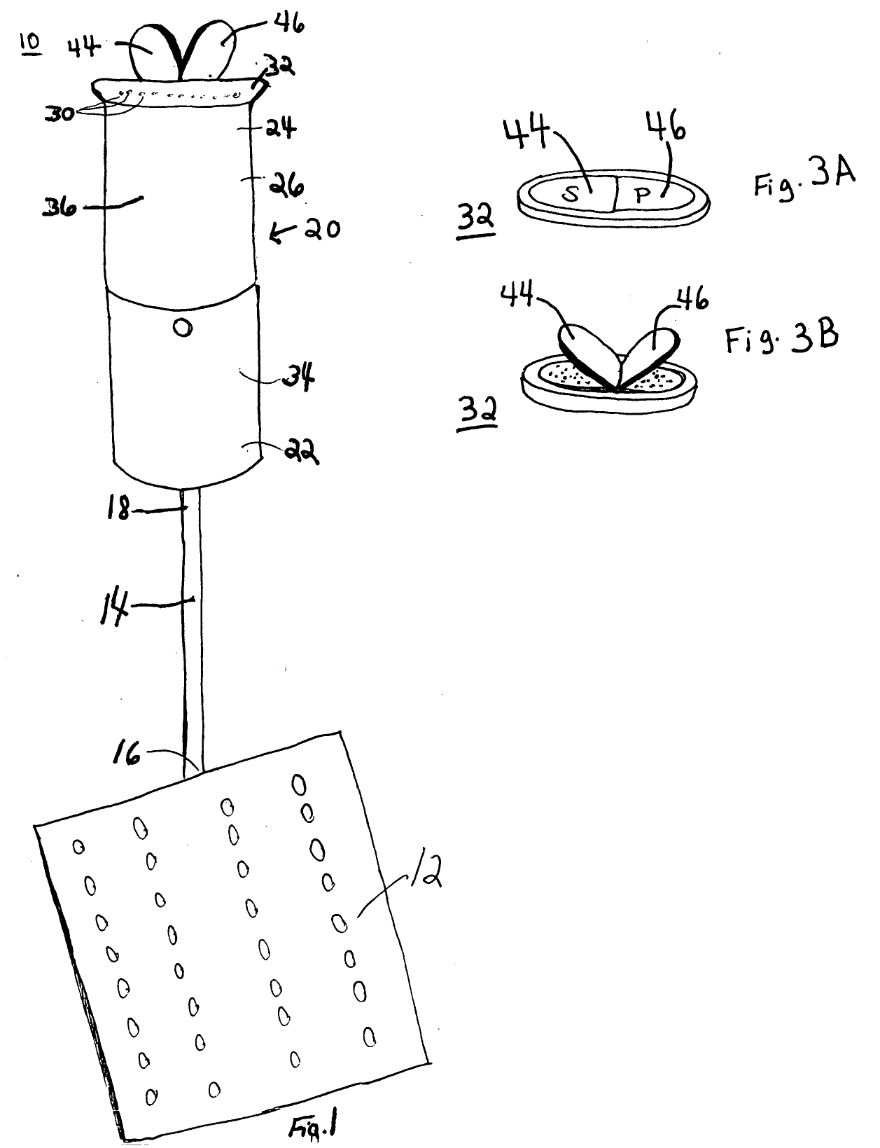

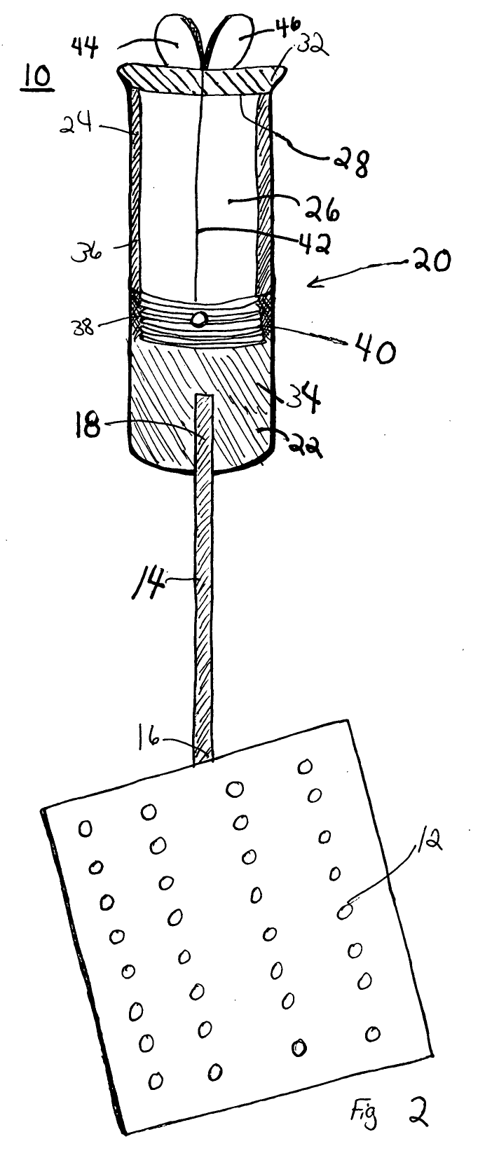

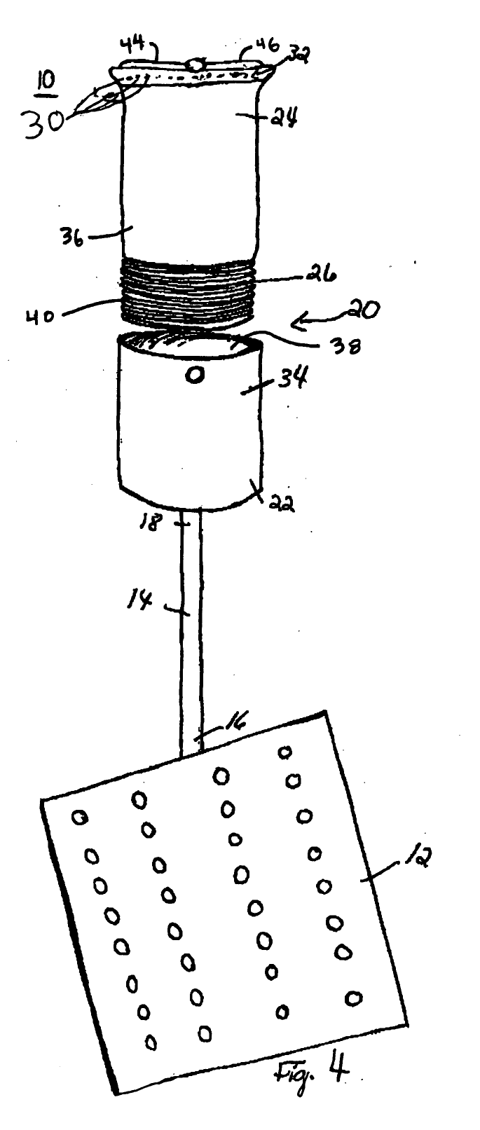

In an optional feature, the hollow section 26 may be further subdivided into two or more separate compartments by a divider 42, which may be integral to the hollow section 26 of the handle 20 or may be separately inserted into the interior of the hollow section 26. The use of separate compartments facilitates the storage of more than one seasoning or other foodstuff in the hollow section 26. However, in order to utilize the plurality of compartments, it may be necessary to utilize a cap 32 such as the exemplary one illustrated in FIGS. 3A & 3B. As shown therein, the cap 32 includes two separate semicircular lids 44, 46, hinged to the body of the cap 32 via a pair of living hinges. In this exemplary embodiment, the lids 44, 46 are labeled for use with compartments containing salt and pepper respectively. However, it will be apparent that alternative indicia (or none at all) may likewise be applied. Preferably, indicia will be utilized to match the foodstuffs to be contained therein, but this is not necessary.

The handle 20 of the utensil 10 is preferably constructed of a resilient, non- or minimal-heat conducting material such as wood, plastic or the like. However, it is likewise contemplated that portions, or the entirety, of the handle 20 may instead be constructed of a wide variety of other materials, including metals, rubber compounds ceramics, or the like. Further, the hollow section 26 may include a liner (not shown), that may or may not be formed from the same material as the rest of the handle 20. The liner may be easier to clean than the surfaces of the hollow section 26 and may provide a more effective non-stick surface than the surfaces of the hollow section 26. For example, a smooth plastic liner may be utilized with a solid wood handle 20. The liner may even be arranged to be removable to further facilitate cleaning thereof. The liner may also be constructed to include the divider 42 described above.

Optionally, the handle 20 may further include two separable portions 34, 36 as perhaps best shown in FIG. 4, which is a side perspective view of the grill utensil 10 of FIG. 1, shown with the first handle portion 34 separated from the second handle portion 36. The first portion 34, which is the operational tool portion, may include the connection to the shaft 14, while the hollow section 26 may be disposed in the second portion 36, which is the shaker portion Significantly, however, the first and second portions 34, 36 additionally include respective connective fittings 38, 40, adapted to removably connect to one another. The fittings 38, 40 make it possible to easily connect and disconnect the first and second handle portions 34, 36 from one another, so as to permit the operational tool 12 and shaker portion 36 to be used separately. Preferably, the connective fittings 38, 40 are correspondingly-threaded male and female fittings, but it will be apparent that other conventional fittings may likewise be utilized, including snap fittings, clamps, twist fittings, pressure fittings, or the like.

In the embodiment shown, the shaker portion 34 is approximately the same diameter as the rest of the handle 20. However, in an alternative embodiment, the shaker portion 34 may be wider than the rest of the handle, thereby allowing for easier refilling of the shaker portion 34.

In another embodiment (not illustrated), the second portion 36 is arranged to fit inside the first portion 34. The second portion 36 may be retained therein by the connective fittings 38, 40.

In use, the hollow section 26 is first filled with the desired foodstuff or foodstuffs, which may be salt, pepper, or any other seasoning or other foodstuff in particulate form. When the utensil 10 is to be used, it is first carried to the cooking site along with the other grilling items. If the handle 20 includes separable portions 34, 36, then the utensil 10 is normally stored and transported with the two portions 34, 36 connected together to minimize the number of separate items that must be carried and accounted for. During grilling, the utensil 10 may be used conventionally, whether the utensil is a fork, tongs, or any other operational tool. When the cook wishes to apply the seasoning or seasonings stored in the hollow section 26 to the meat or other food being cooked, the cook simply opens the cap 32 as necessary, turns the utensil 10 upside down and shakes the seasoning out through the perforations 30.

In an alternative method of use, useful when separable first and second portions 34, 36 are provided, the hollow shaker portion 36 may be removed from the first portion 34 while the operational tool 12 is being used. However, the two portions 34, 36 of the handle 20 may still be connected when transporting and storing the utensil 10.

Any of the foregoing embodiments may further be incorporated into a set of two or more utensils 10 of any of the types described hereinabove. For example, a set of two utensils 10 may include a meat fork and a set of tongs, wherein one utensil 10 includes a salt shaker in its handle 20, while the other utensil 10 includes a pepper shaker in its handle 20. Other combinations will be readily apparent to those of ordinary skill in the art.

Based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its preferred embodiment, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof. Although specific terms are employed herein, they are used in a generic and descriptive sense only and not for the purpose of limitation.

What is claimed is:

1. A combined cooking utensil and seasoning dispenser, comprising:
an operational tool; a shaft, having a first end connected at one end to the operational tool and a second end opposite the first end; and a hollow portion, connected to the second end of the shaft and adapted to store a seasoning in particulate form, with openings for shaking the seasoning therethrough.

2. A combined cooking utensil and seasoning dispenser, comprising:
a first element with having a hollow portion adapted to store a seasoning in particulate form, the hollow portion including openings for shaking the seasoning therethrough and a first connective fitting; and a second element having a second connective fitting at a first end and an operational tool at a second end, the second end being opposite the first end, wherein the second connective fitting is adapted to mate with the first connective fitting.

3. A combined cooking utensil and seasoning dispenser, comprising:
a hollow portion adapted to store a seasoning which, unlike prior art, can be separated and used as a stand alone dispenser without seasonings escaping from the bottom. The hollow portion adapted to store a seasoning can be placed in a storage area while the operational tool portion is dishwashed (this is a giant advancement from prior art which had openings in both ends of hollow dispenser and could not be separated without emptying the contents).
